(19) United States
(12) Patent Application Publication
(10) Pub. No.: US 2014/0321477 A1
(43) Pub. Date: Oct. 30, 2014

(54) DEVICE FOR SELECTIVELY CONNECTING A FIRST ITEM OF EQUIPMENT TO A PLURALITY OF SECOND ITEMS OF EQUIPMENT, AND DATA PROCESSING ASSEMBLY COMPRISING SUCH A DEVICE

(71) Applicant: SAGEM DEFENSE SECURITE, Boulogne Billancourt (FR)

(72) Inventors: Bruno Larois, Boulogne Billancourt (FR); Denis Delville, Boulogne Billancourt (FR); Jean-Marie Courteille, Boulogne Billancourt (FR); Patrick Valette, Boulogne Billancourt (FR)

(21) Appl. No.: 14/354,914

(22) PCT Filed: Nov. 16, 2012
(86) PCT No.: PCT/EP2012/072852

§ 371 Date: Apr. 28, 2014

(30) Foreign Application Priority Data
Nov. 17, 2011 (FR) 1160466

(51) Int. Cl. H04L 12/931; H04L 12/937

(52) U.S. Cl. CPC H04L 49/351; H04L 49/253
USPC 370/419

(57) ABSTRACT

A device for selective connection of at least one first piece of computer equipment to a plurality of second pieces of computer equipment. The device comprising a first Ethernet port for connection to the first equipment, second Ethernet ports for connection to each of the second pieces of equipment, a selector arranged to connect the first Ethernet port physically and in selective manner to the second Ethernet ports, and a selector control unit. A data processing assembly comprising pieces of equipment connected to at least one such connection device.

The present invention relates to a device for selectively connecting a first piece of computer equipment to a plurality of second pieces of computer equipment. The invention also provides a data processor assembly including at least one such device.

Such connection devices are useful in numerous fields, and more particularly in the field of aviation.

Thus, in an aircraft, it is known to connect a data loading and downloading unit (commonly referred to as a “data loader”) to the computers of the aircraft in order to load programs or updates into the computers, or in order to download the data. The ARINC 615A standard provides for using the Ethernet protocol in order to connect the loading and downloading unit to the computers.

It is necessary to interpose a connection device between the loading and downloading unit and the computers in order to connect the loading and downloading unit selectively to each of the computers. The connection device may be an Ethernet router (also known as a “switch”) that serves to route data packets between the loading and downloading unit and the computers. In such a router, the ports of the router are permanently connected to one another, and it is the router that determines the ports to which data frames reaching the router should be transferred as a function of addresses contained in the frames. Such a router cannot prevent data being transferred between the computers, e.g. as a result of executing a malware program. In particular, it is essential to prevent a program being loaded into any of the computers while the aircraft is in the air.

A more elaborate connection device that it is possible to use comprises a secure communications interface having a dedicated computer programmed to prevent such program loading in flight. Nevertheless, such an interface is expensive.

An object of the invention is to provide means for connecting a first piece of computer equipment to a plurality of second pieces of computer equipment in a manner that is simple, reliable, and secure.

For this purpose, the invention provides a device for selective connection of at least one first piece of computer equipment to a plurality of second pieces of computer equipment, the device comprising a first Ethernet port for connection to the first equipment, second Ethernet ports for connection to each of the second pieces of equipment, a selector arranged to connect the first Ethernet port physically and in selective manner to the second Ethernet ports, and a selector control unit.

Thus, the connection device provides physical switching of the first Ethernet port to each of the second Ethernet ports while isolating the second Ethernet ports from one another. This arrangement of the connection device enables the computers to be isolated from one another and as a result guarantees computer security for the information system. This is therefore not mere routing of data between pieces of equipment, but rather connecting the first piece of equipment to each of the second pieces of equipment.

Advantageously, the selector has a disconnection position in which all of the second Ethernet ports are disconnected.

In this position, the selector prevents any transmission taking place between the pieces of computer equipment.

It is then preferable, for the control unit to be programmed in such a manner that the selector is in the position for disconnecting all of the second Ethernet ports when the control unit is not powered.

In an application on board an aircraft, provision may be made for the control unit to be powered only when the aircraft is on the ground, so that it is not possible to load a program into a second piece of equipment whenever the aircraft is in flight.

According to another advantageous characteristic, the device includes a discrete signal inlet port, and preferably:
the device includes at least as many discrete signal outlet ports as there are second Ethernet ports, and the selector is arranged to connect the discrete inlet port physically and in selective manner to the discrete outlet ports; and/or
the control unit is programmed in such a manner that the selector is in a position for disconnecting all of the discrete outlet ports when no discrete signal is present on the inlet port.

The presence of the discrete signal can then constitute authorization to transfer data.

Also advantageously, the device includes a chaining port for chaining to at least one connection device of the same type, and the control unit is arranged to transmit thereto any frame that is not addressed to the second pieces of equipment to which the connection device is connected.

This makes it possible to increase the number of second pieces of equipment that can be connected to the first piece of equipment.

The invention also provides a data processor assembly including at least one such connection device connecting to pieces of computer equipment.

Other characteristics and advantages of the invention appear on reading the following description of a particular, nonlimiting embodiment of the invention.

Reference is made to the accompanying drawings, in which:

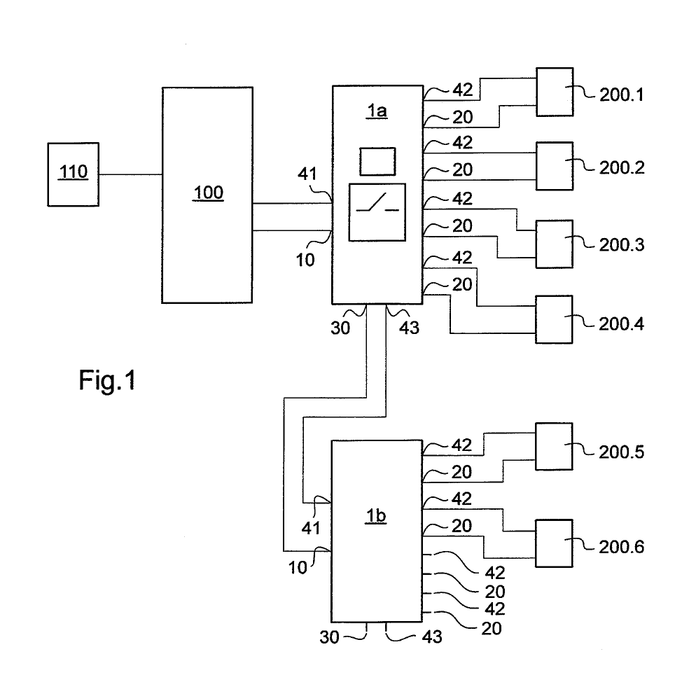

FIG. 1 is an overall diagrammatic view of a system comprising data-processing equipment connected by connection devices in accordance with the invention; and

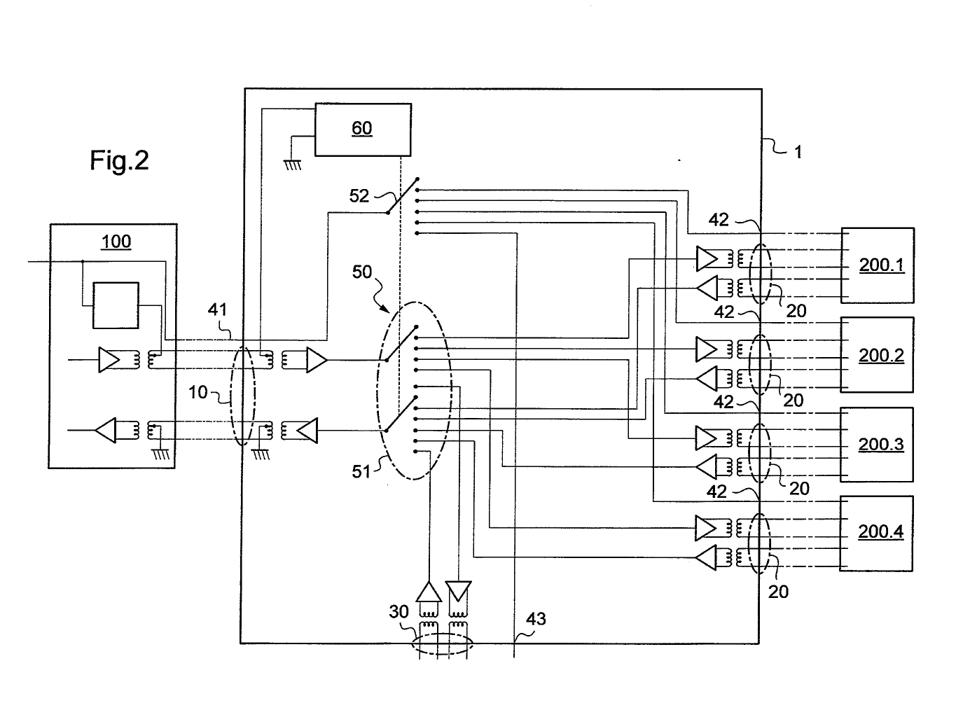

FIG. 2 is a diagrammatic view of the connection device and of its link with a loading and downloading unit.

With reference to the figures, the connection device in accordance with the invention, given overall reference 1, is described herein in an aviation application for connecting a loading and downloading unit 100 to computers 200 on-board an aircraft (there being six computers in this example, which are individualized by means of indices 1 to 6 appended to the numerical reference 200 in FIG. 1). The loading and downloading unit 100 (or “data loader”) that is used as an operator interface and it forms “first” computer equipment, while the computers 200, that form pieces of “second” computer equipment, are themselves known and they are not described in greater detail herein.

The connection device 1 has a first Ethernet port 10 for connecting to the loading and downloading unit 100, and second Ethernet ports 20 (four of them in this example) for connection to computers 200.

In this example, the Ethernet port 10 is connected to the loading and downloading unit 100 via a bidirectional Ethernet link (complying with the specifications of ARINC standard 615A) that comprises in conventional manner an up line and a down line, which lines are electrically isolated.

In this example, each Ethernet port 20 is connected to one of the computers 200 via a bidirectional Ethernet link (complying with the specifications of ARINC standard 615A) that comprises in conventional manner an up line and a down line, which lines are electrically isolated.

Each connection device 1 includes a chaining Ethernet port 30 suitable for connecting the connection device to the Ethernet port 10 of another connection device 1 via a bidirectional Ethernet link of the above-mentioned type.

Each connection device 1 also has an inlet port 41 for a discrete signal, and as many outlet ports 42 for the discrete signal as there are Ethernet ports 20, and an outlet port 43 for the discrete signal for chaining with another connection device 1. The discrete ports 41, 42, and 43 are for connecting respectively to the loading and downloading unit 100, to the computers 200, and to the other connection device 1. The connection device 1 includes a selector given overall reference 50 comprising a first selector 51 connected between firstly the Ethernet port 10 and secondly the Ethernet ports 20, and the Ethernet chaining port 30 in order to connect the Ethernet port 10 physically and in selective manner to any one of the Ethernet ports 20 or to the chaining Ethernet port 30. The selector 51 thus has as many connection positions as there are Ethernet ports 20 plus the chaining Ethernet port 30 so as to be capable of selectively connecting the Ethernet port 10 to any one of the Ethernet ports 20 or to the chaining Ethernet port 30. The selector 51 also has a disconnection position in which all of the Ethernet ports 20 and the chaining Ethernet port 30 are disconnected so that the Ethernet port 20, the Ethernet ports 20, and the chaining Ethernet port 30 are isolated from one another.

The selector 50 further comprises a second selector 52 that is connected in series between firstly the inlet port 41 and secondly the discrete outlet ports 42 and the discrete outlet port 43, and that is arranged to connect the discrete inlet port 41 physically and in selective manner to any one of the discrete outlet ports 42 or to the discrete outlet port 43. The selector 52 thus has as many connection positions as there are discrete outlet ports 42 plus the discrete outlet port 43, and it has a disconnection position in which all of the discrete outlet ports 42 and the discrete outlet port 43 are disconnected so that the discrete inlet port 41, the discrete outlet ports 42, and the discrete outlet port 43 are isolated from one another.

The selector 50 is provided with a control unit 60 for controlling the selectors 51 and 52 of the selector 50. In this example, the control unit 60 is a programmable logic circuit programmed in such a manner that the selectors 51 and 52 of the selector 50 are in the disconnection position when the control unit 60 is not powered and when no discrete signal is present on the discrete inlet port 41.

The power supply is preferably provided via the loading and downloading unit 100 by delivering power over the Ethernet line connected to the Ethernet port 10. This method of powering equipment connected to an Ethernet network is itself known. Thus, the control unit 60 can be powered only when the loading and downloading unit 100 is itself connected to the connection device 1 and is powered.

In the presently described example, the number of computers 200 (six) is greater than the number of Ethernet ports 20 (four) of the connection device 1. Provision is thus made to use a second connection device 1 (the connection devices 1 are identical in structure and they are distinguished in the figures by means of the letters a and b associated with the numerical reference 1).

The connection device 1a thus has its four Ethernet ports 20 and its four discrete outlet ports 42 connected to the computers 200.1, 200.2, 200.3, and 200.4, its chaining Ethernet port 30 connected to the Ethernet port 10 of the second connection device 1b, and its discrete outlet port 43 connected to the discrete inlet port 41 of the second connection device 1b. The connection device 1b has two of its Ethernet ports 20 connected respectively to the computers 200.5 and 200.6, and two of its discrete outlet ports 42 connected respectively to the computers 200.5 and 200.6. The other two Ethernet ports 20 and the other two discrete outlet ports 42 of the connection device 1b, and also the chaining Ethernet port 30 and the discrete outlet port 43 are not connected.

In operation, an operator seeking to load or download data to or from one of the computers needs to connect the loading and downloading unit 100 to the connection device 1a, to a power supply, and to the air/ground sensor 110 of the aircraft. The connection device 1a is then electrically powered.

The data is transmitted to a computer by beginning by sending a switching control frame mentioning an identifier M (of value 1, 2, 3, 4 . . . ) corresponding to the computer in question.

If a data frame reaches the connection device 1a for delivery to the computer 200.M:
if M is less than N (representing the number of Ethernet ports 20 of the connection device 1a), then the control unit 60 causes the selector 50 to connect the Ethernet port 10 to the Ethernet port 20 #M to which the computer 200.M is connected so as to send the data frame to that computer;
if M is greater than N, the control unit 60 of the connection device 1a sends a data frame with a corrected identifier M-N to the connection device 1b to control the selector 50 to connect the Ethernet port 10 to the chaining Ethernet port 30 and the discrete inlet port 41 to the discrete outlet port 43. The control unit 60 of the connection device 1b is then powered and controls the selector 50 to connect the Ethernet port 10 to the Ethernet port 20 #M-N to which the computer 200.M is connected so as to send the data thereto.

Thus, in more detailed manner, assuming that the data is to be loaded into the computer 200.2, the operator uses the loading and downloading device 100 to send a user datagram protocol (UDP) switching frame containing the number of the Ethernet port 20 to be connected, i.e. in this example the Ethernet port 20 #2. On receiving it, the control unit 60 of the connection device 1a verifies that the number of the port is less than the number of Ethernet ports 20 that it possesses. If so, then the control unit 60 causes the selectors 51 and 52 to take up their corresponding positions. The computer 200.2 is then ready to load data.

The loading and downloading device 100 issues a new UDP frame containing a status request to the control unit 60 which responds to the request by returning the number of the Ethernet port 20 connected via the selector 51.

If the response from the control unit 60 complies with the expected response, then the loading and downloading device 100 sends the data frame that is to be loaded.

This procedure is repeated for each computer into which data is to be loaded. The same applies for the computers from which data is to be downloaded.

Assuming that the data is to be loaded into the computer 200.5, the operator uses the loading and downloading device 100 to send a UDP frame containing the number of the Ethernet port 20 to be connected, i.e. in this example the Ethernet port 20 #5 in the overall configuration of the connection system. On receiving it, the control unit 60 of the connection device 1a verifies that the number of the Ethernet port 20 is less than the number of Ethernet ports 20 that it possesses. If this is not so, the control unit 60 subtracts the total number of Ethernet ports 20 of the device 1a from the number contained in the frame and it generates a UDP switching control frame in which it inserts the result of this subtraction, and in this example the result is 1. The control unit 60 then causes the selectors 51 and 52 to connect to the chaining Ethernet port 30 and to the discrete outlet port 43 and it forwards the UDP frame to the connection device 1b.

The control unit 60 of the connection device 1b operates in the same manner as the control device 1a.

Status is then verified as above. The status frame returned by the control unit 60 of the connection device 1b contains the number of the Ethernet port 20 connected via the selector 50, and it is transmitted to the connection device 1a. The control unit 60 of the connection device 1a then generates a status frame into which it inserts the sum of the number transmitted by the connection device 1b plus the number of Ethernet ports 20 in the connection device 1a as the number of the Ethernet port 20 that is connected. If the status frame complies with expectations, then the loading and downloading device 100 sends the data frame that is to be loaded.

Naturally, the invention is not limited to the embodiment described above but covers any variant coming within the ambit of the invention as defined by the claims.

In particular, although the above described connection device 1 can be connected to only four computers 200 in this example, it will naturally be understood that the connection device 1 may be arranged to be capable of being connected to some other number of computers 200.

It is possible to use a single connection device or a plurality of connection devices connected in cascade, the number of connection devices possibly being equal to one, two, or more.

The discrete signal inlet and outlet ports are optional, in particular in non-aviation applications.

The programmable logic circuit of the control unit 60 may be replaced by any equivalent means, and in particular by discrete components, a microcontroller, etc.

Whether data loading and downloading is or is not authorized may be associated with activating some other type of detector or with manually actuating a button dedicated to this purpose. Above, data loading and downloading is authorized or not authorized in association with the sensor 110 being activated or deactivated: it is possible to provide means enabling authorization to be forced, e.g. in the event of particular maintenance operations.

It is possible for all or some of the connection devices to be powered permanently, either directly or else via the loading and downloading unit 100. Permanently powering the connection devices is advantageous in that it makes it possible to undertake periodic diagnoses of proper operation other than when selecting and/or loading or downloading data in the future.

It is possible to provide two discrete signal inlets in the connection devices. One of these inlets receives the discrete signal directly from the loading and downloading unit 100, and the other one of these inlets receives the discrete signal coming from an upstream connection device. A port of a connection device can then be selected only if the discrete signal is present on both inlets of said connection device (for the connection device that is furthest upstream, the two inlets are connected directly to the loading and downloading unit).

The invention is applicable to any type of digital bus and in particular to a bus of the AFDX type or any other variety of Ethernet.

The invention applies equally well to any data rate (e.g. gigabit/s) and to any Ethernet medium (e.g. optical fiber).

1. A device for selective connection of at least one first piece of computer equipment to a plurality of second pieces of computer equipment, the device comprising a first Ethernet port for connection to the first equipment, second Ethernet ports for connection to each of the second pieces of equipment, a selector arranged to connect the first Ethernet port physically and in selective manner to the second Ethernet ports, and a selector control unit.

2. The device according to claim 1, wherein the selector has a disconnection position in which all of the second Ethernet ports are disconnected.

3. The device according to claim 2, wherein the control unit is programmed in such a manner that the selector is in the position for disconnecting all of the second Ethernet ports when the control unit is not powered.

4. The device according to claim 1, including a discrete signal inlet port.

5. The device according to claim 4, including at least as many discrete signal outlet ports as there are second Ethernet ports, and the selector is arranged to connect the discrete inlet port physically and in selective manner to the discrete outlet ports.

6. The device according to claim 4, wherein the control unit is programmed in such a manner that the selector is in a position for disconnecting all of the discrete outlet ports when no discrete signal is present on the inlet port.

7. The device according to claim 4, including a discrete chaining outlet for chaining to at least one connection device of the same type, and the control unit is arranged to transmit thereto any frame that is not addressed to the second pieces of equipment to which the connection device is connected.

8. The device according to claim 1, including a chaining Ethernet port for chaining to at least one connection device of the same type, and the control unit is arranged to transmit thereto any frame that is not addressed to the second pieces of equipment to which the connection device is connected.

9. The data processing assembly according to claim 1, comprising pieces of equipment connected to at least one connection device.
